(19) United States
(12) Patent Application Publication
(10) Pub. No.: US 2003/0149582 A1
(43) Pub. Date: Aug. 7, 2003

(54) Record medium, and apparatus and method for data processing

(76) Inventor: Yoichiro Sako, Tokyo (JP)

Correspondence Address: Jay H Maioli, Cooper & Dunham, 1185 Avenue of the Americas, New York, NY, 10036, US

(21) Appl. No.: 10/220,677

(22) PCT Filed: Jan. 15, 2002
(86) PCT No.: PCT/JP02/00203

(30) Foreign Application Priority Data
Jan. 15, 2001 (JP) 2001-006843

(51) Int. Cl. G06F 17/60

(52) U.S. Cl. 705/1

(57) ABSTRACT

The present invention provides a data processing method for a recording medium comprising: a step of determining fee-charge method identification data extracted from recording data read from a recording medium on which the recording data constructed by a header data part and a data part, which is continuous to the header data part and includes data of a content, is recorded, with the header data part including the fee-charge method identification data for identifying a fee-charge method when executing an operation based on the data in the data part; a step of carrying out fee-charge processing, based on the determined fee-charge method; and a step of starting execution of the operation based on the data of the data part if it is determined that the fee-charge processing has been completed normally.

### TECHNICAL FIELD

The present invention relates to a recording medium which records a program capable of money charge processing when reproducing a program such as game software or the like, and a data processing apparatus and a method thereof which can perform the money charge processing when the program is reproduced.

### Background Art

Conventionally, contents of game software or the like are supplied in form of recording media such as a read-only optical discs (hereinafter called an optical disc of ROM (Read Only Memory) type), a read-only tape cassette (hereinafter called a cassette of ROM type), and the like. When a user wants game software, the user can purchase and obtain a recording medium on which game software is recorded, in dealer shops. The user can enjoy the game software by reproducing the recording medium by a home-use game machine as a household reproducing apparatus.

In case of an arcade game machine as a professional-use game reproduction apparatus placed in a game arcade and the like, users can enjoy one game for a predetermined price or an arcade game for a predetermined time period, by inserting a coin or a prepaid card.

However, games are roughly divided into two types. Long-time games such as roll-playing games (hereinafter simply called RPGs) or simulation games, and short-time games such as shooting games, fighting games, action games, racing games or the like.

In case of game software for a home-use game machine, the user firstly have to purchase a recording medium on which software data is recorded. The user cannot try a desired game before purchase. In case of an arcade game machine, one user may sometimes occupy one game machine for a long-time game of RPG type as described above. Therefore, short-time games are solely supplied, and long-time games are not supplied.

### Disclosure of the Invention

An object of the present invention is to provide a recording medium recording a program capable of supplying contents such as games at low prices without depending on spots such as homes or game arcades, by performing fee-charge processing in correspondence with the types of contents such as games, and a data processing apparatus and a method thereof which can execute the program.

To achieve the object as described above, a recording medium according to the present invention records recording data constructed by a header data part-and a data part, which is continuous to the header data part and includes data of a content. The header data part of the recording data includes fee-charge method identification data for identifying a fee-charge method when executing an operation based on the data in the data part. The fee-charge method identification data indicates at least one of data expressing time-dependent fee-charge by which a fee is charged in units of time periods for executing the operation based on the data of the data part, and data expressing fee-charge by which a fee is charged every time when the operation based on the data of the data part.

The header data part further includes identification data expressing a type of the data of the content recorded on the data part, and the fee-charge method identification data is set based on the identification data expressing the type. The header data part further includes data concerning a fee-charge amount for making fee-charge processing, based on the fee-charge method identified by the fee-charge method identification data, and also further includes identification data expressing whether or not a function to hold a state in which execution of an operation is paused based on the data in the data part.

A data processing method for a recording medium, according to the present invention, comprises: a step of determining fee-charge method identification data extracted from recording data read from a recording medium on which the recording data constructed by a header data part and a data part, which is continuous to the header data part and includes data of a content, is recorded, with the header data part including the fee-charge method identification data for identifying a fee-charge method when executing an operation based on the data in the data part; a step of carrying out fee-charge processing, based on the determined fee-charge method; and a step of starting execution of the operation based on the data of the data part if it is determined that the fee-charge processing has been completed normally.

A data processing method for a recording medium, according to the present invention, comprises: a step of determining fee-charge method identification data extracted from data constructed by a header data part and a data part, which is continuous to the header data part and includes data of a content, with the header data part including the fee-charge method identification data for identifying a fee-charge method when executing an operation based on the data in the data part; a step of carrying out fee-charge processing, based on the determined fee-charge method; and a step of starting execution of the operation based on the data of the data part if it is determined that the fee-charge processing has been completed normally.

A data processing apparatus according to the present invention comprises: a reproduction part which reproduces data constructed by a header data part and a data part, which is continuous to the header data part and includes data of a content, with the header data part including fee-charge method identification data for identifying a fee-charge method when executing an operation based on the data in the data part; a detennination part which determines the fee-charge method identification data extracted by the reproduction part; a fee-charge processing part which performs fee-charge processing, based on the fee-charge method determined by the determination part; and a control part which starts execution of the operation based on the data of the data part when it is determined that the fee-charge processing has been completed normally.

A game apparatus according to the present invention comprises: a reproduction part which reads and reproduces program data from a recording medium on which the program data constructed by a header data part and a data part, which is continuous to the header data part and includes data of a content, is recorded, with the header data part including fee-charge method identification data for identifying a fee-charge method when executing an operation based on the data in the data part; a determination part which determines the fee-charge method identification data extracted by the reproduction part; a fee-charge processing part which performs fee-charge processing, based on the fee-charge method determined by the determination part; and a control part which starts a game based on data of the data part, which concerns the game, execution of the operation based on the data of the data part when it is determined that the fee-charge processing has been completed normally.

Other objects of the present invention and specific advantages obtained by the present invention will be more clearly understood from the description of embodiments which will be made below.

### BRIEF DESCRIPTION OF THE DRAWINGS

FIG. 1 is a diagram which explains the format of a program to which the present invention is applied;

FIG. 2 is a table which explains the relationship among genres of contents, effective/ineffective of a save function, and fee-charge methods;

FIG. 3 is a block diagram of a data processing apparatus to which the present invention is applied;

FIG. 4 is a flowchart which explains a procedure in which a data processing apparatus identifies the fee-charge method;

FIG. 5 is a flowchart which explains a procedure when the fee-charge method is time-dependent fee-charge;

FIG. 6 is a flowchart which explains a procedure when the fee-charge method is spot fee-charge;

FIG. 7 is a flowchart which explains a procedure when the fee-charge method is purchase fee-charge; and

FIG. 8 is a flowchart which explains a procedure when the fee-charge method is free.

### BEST MODE FOR CARRYING OUT THE INVENTION

Hereinafter, a recording medium and a data processing apparatus to which the present invention is applied will be explained with reference to the drawings.

The recording medium to which the present invention is applied is an optical disc, a cassette, or the like of ROM type, and records program data which can be processed by a data processing apparatus. Recorded as the program data to be recorded on this recording medium is, for example, data concerning a game. A specific example thereof will be data concerning game software of a long-time play type such as a RPG, simulation game, or the like which is played over a long time period, or data concerning game software of short-time play type such as a shooting game, action game, racing game, or the like which ends in a short time period.

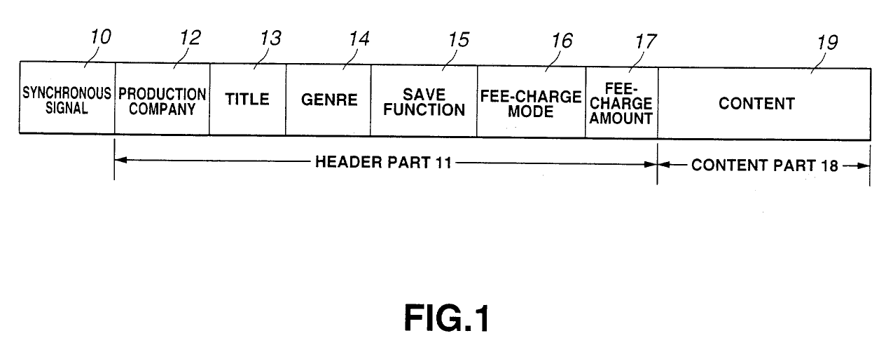

With respect to this program data, for example, a synchronous signal 10 is provided as shown in FIG. 1 and is constructed by a header part 11 and a content part 18 provided subsequently to the synchronous signal 10. The header part 11 is constructed by production company identification data 12 for identifying the production company of the game software as a content, title data 13 indicating the title of the game, genre data 14 indicating the genre of the game, control data 15 having a save function to save the progress of the game contained in the game software as a content, fee-charge identification data 16 indicating a fee-charge method, and charge amount data 17 indicating the charged amount. The content part 18 records data concerning the game as a content, i.e., program data 19 concerning the game.

The genre data 14 indicates the type of data 19 concerning the game as a content, i.e., whether the data 19 concerning the game is a long-tine play type game such as a RPG, simulation game, or the like, which takes a long time for user to play, a short-time play type game such as a shooting game, action game, racing game, or the like, which ends in a short time period. Of course, this genre data 14 may be data indicating which of the RPG, simulation game, shooting game to shoot a target, action game to make a virtual fight, and racing game the game belongs to.

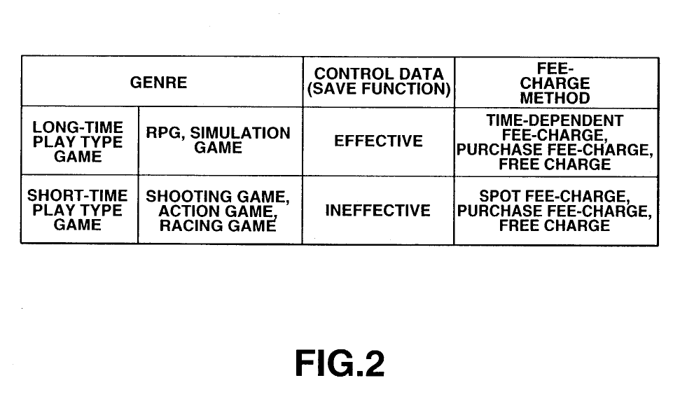

The control data 15 serves to control a save means contained in the data 19 concerning the game, i.e., effective/ineffective of the function to save the progress of the game. For example, as shown in FIG. 2, if the genre data 14 indicates that the data 19 is of a long-time play type game, the control data 15 indicates that the save function is set effective because the time to the end of one game is long, i.e., a long time is required until one game progresses to its end. Alternatively, if the genre data 14 indicates that the data 19 concerning the game is of a short-time play type game, the save function is set ineffective because the time to the end of one game is short. For example, the control data 15 is expressed by two bits. If the data is “00”, the save function is set ineffective. Alternatively, if the data is “01”, the save function is set effective. “10” and “11” are reserved.

The control data 15 does not switch the save function between effective and ineffective depending on whether the game is a long-time play type game or a short-time play type game but classifies games depending on genres of the respective games. For example, if the game is a RPG, a simulation game, or the like, it takes a long time until the user proceeds with the game to the end so that the save function may be set effective. Alternatively, if it is a shooting game, action game, racing game, or the like, it takes a short time until one game ends so that the save function may be set ineffective.

The fee-charge method identification data 16 is data for identifying the fee-charge method when executing the data 19 concerning the game. Specifically, if a fee is charged to execute data 19 concerning the game, whether the fee should be charged or not. If a fee is charged, whether the charge should be time-dependent fee-charge in units of time periods or spot fee-charge which charges a fee every time when the content of the data 19 is executed. Of course, the fee-charge method identification data is data indicating that the charge is free if charge is not necessary to execute the data 19 concerning the game. As shown in FIG. 2, when the genre data 14 indicates that the data 19 is a long-time play type game, the fee-charge method identification data 16 is set so as to indicate the time-dependent fee-charge because the time until the game ends is long. When the genre data 14 indicates that the data 19 is a short-time play type game, the data 16 is set so as to indicate the spot fee-charge because the time till one game ends in a short time period.

Where games are classified depending on the types of respective games, the fee-charge method identification data 16 may be set so as to indicate the time-dependent fee-charge because the time until one game ends is long if the genre data 14 indicates a RPG, simulation game, or the like. If the genre data 14 indicates a shooting game, action game, racing game, or the like, the data 16 may be set so as to indicate the spot fee-charge.

In games of any genres, the fee-charge method identification data 16 may be set so as to indicate free charge or purchase. When an arcade game machine is used, the charge method identification data 16 is set to either the time-dependent fee-charge or spot fee-charge. When a home-use game machine is used, the fee-charge method identification data 16 is set any one of the above four types.

The fee-charge method identification data 16 as described above is expressed by, for example, four bits. When the data is “0000”, free charge is set. When the data is “0X01”, the time-dependent charge is set. When the data is “0X10”, the spot fee-charge is set. When the data is “01XX”, purchase is adopted. “X” indicates “don't care”, the others are received.

The fee amount data 17 is data indicating the fee amount when the fee-charge method identification data 16 is set to any one of the time-dependent fee-charge, spot fee-charge, or purchase, and is expressed by 16 bits×2 bits. For example, when the charge method identification data 16 is the time-dependent fee-charge “0X01”, the fee amount data 17 is set to ¥20 per minute. When the fee-charge method identification data 16 is the spot fee-charge “0X10”, the data 17 is set to ¥100 per one spot use. When the fee-charge method identification data 16 is the purchase “01XX”, a purchase price of ¥2,000 is set.

In the program constructed as described above, an optimal fee-charge method can be determined in accordance with the type of the game as a content. That is, as shown in FIG. 2, if the data 19 concerning the game is a RPG, simulation game, or the like, or a long-time play type game which requires a long time until one game ends, the time period for which the user reproduces and plays the game is long, i.e., the play time is long. Hence, if the fee-charge method is set to the spot charge, the fee-charge amount needs to be set high. Since the present invention can charge a fee in accordance with the play time period, monetary burdens to the user can be reduced. Therefore, this kind of program data as shown in FIG. 1 can be enjoyed not only by a home-use game machine but also by an arcade game machine. Even after the game is once paused midways, the game can be continued from the point at which the game was paused last, for the next time when the game is played, by using the save function for the program data shown in FIG. 1 as described above. If the data 19 concerning the game is a short-time play type game such as a shooting game, action game, racing game, or the like in which the play time period of one game is short, the fee-charge method can be set to the spot fee-charge.

In games of any genres, the unit price to play one game or play a game for a predetermined time period can be set to be low. Therefore, before the user actually purchases a recording medium on which desired program data is recorded, the user can try to play the game, based on program data added with fee-charge data for spot fee-charge, time-dependent fee-charge, or the like. In this case, the control data 15 can set the save function ineffective.

Although explanation has been made of an example in which the program data is provided by recording medium shown in FIG. 1, this program can be downloaded from a server apparatus to a data processing apparatus such as a game machine or the like through a network.

Next explanation will be made of a data processing apparatus 30 which executes the above-mentioned program to which the present invention is applied.

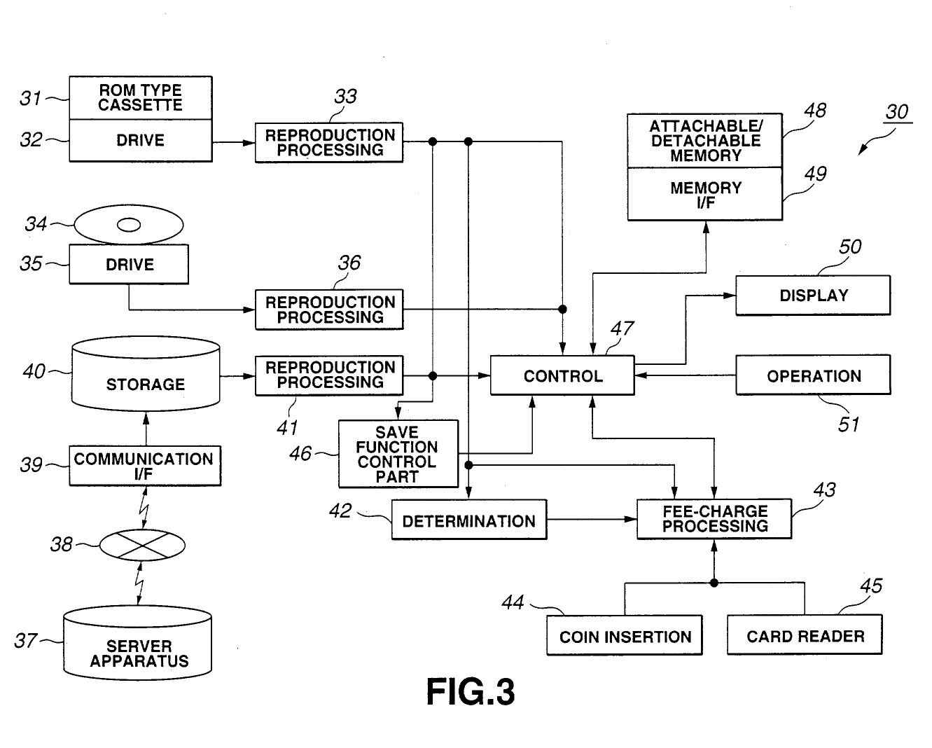

As shown in FIG. 3, this data processing apparatus 30 comprises: a drive 32 to which a ROM type cassette 31 storing the program data shown in FIG. 1 is attached; a reproduction processing part 33 which performs reproduction processing on the program data read by the drive 32; a drive 35 to which a ROM type optical disc 34 storing program data is attached; a reproduction processing part 36 which performs reproduction processing on the program data read by an optical pickup not shown but constituting the drive 35; a communication interface (hereinafter called a communication I/F) 39 which receives the program data through a network 38 such as Internet or the like from the server apparatus 37; a storage part 40 constructed by a hard disc or the like storing the program data downloaded from the server apparatus 37; and a reproduction processing part 41 which performs reproduction processing on the program data read from the storage part.

The reproduction processing parts 33, 36, and 41 demodulate program data as output data read from the ROM type cassette 31, ROM type optical disc 34, or storage part 40, in a predetermined system, and performs processing such as an error correction or the like. The reproduction processing parts 33, 36, and 41 output the data 19 concerning the game in the program data, and also output the control data 15 extracted from the program data to the save function control part 46. The reproduction processing parts 33, 36, and 41 output the fee-charge method identification data 16 extracted from the program data, to a determination part 42, and also output the fee-charge amount data 17 to the fee-charge processing part 43.

The data processing apparatus 30 comprises: a determination part 42 which determines the fee-charge method, based on the fee-charge method identification data 16; a fee-charge processing part 43 which performs fee-charge processing, based on the fee-charge amount data 17; a coin insertion part 44 into which coins are inserted; a card reader 45 into which a card such as a prepaid card, credit card, or the like is inserted; a save function control part 46 which controls the save function; and a control part 47 which controls the entire operation, based on the program data inputted from the reproduction processing parts 33, 36, and 41.

The determination part 42 is inputted with the fee-charge method identification data 16 extracted from the program data by the reproduction processing parts 33, 36, and 41, and executes the data 19 concerning the game, i.e., the fee-charge method during reproduction. Specifically, if the fee-charge method identification data 16 is “0000”, the detennination part 42 determines free charge. If the fee-charge method identification data 16 is “0X01”, the part 42 determines time-dependent fee-charge. If the fee-charge method identification data 16 is “0X10”, the part 42 determines spot fee-charge. If the data 16 is “01XX”, the part determines purchase. The determination part 42 outputs a determination result of the fee-charge method identification data to the fee-charge processing part 43.

The fee-charge processing part 43 is inputted with the fee-charge amount data 17 extracted from the program data by the reproduction processing parts 33, 36, and 41. The fee-charge processing part 43 calculates the sum of coins inserted from the coin insertion part 44, and also calculates the balance of the prepaid card in case where a card is inserted into the card reader 45. The fee-charge processing part 43 carries out fee-charge processing for a fee-charge amount based on the fee-charge amount data 17, in the fee-charge method determined by the determination part 42. The fee-charge processing part 43 outputs whether or not fee-charge processing could be carried out, i.e., whether or not coins equivalent to or more than a predetermined amount of money were inserted so that fee-charge processing could be carried out. Alternatively, whether or not the balance of the card was equivalent to or more than the fee-charge amount so that the fee-charge processing could be carried out is outputted to the control part 47.

The save function control part 46 is inputted with the control data 15 extracted from the program data by the reproduction processing parts 33, 36, and 41. The save function control part 46 supplies the control part 47 with control data such that the save function is set ineffective when the control data 15 is “00” as well as effective when the control data 15 is “01”.

The save function control part 46 controls the control part 47 in place of the control data 15, to set the save function effective, if the genre data 14 of the program data is a long-time play type game, RPG, simulation game, or the like. Alternatively, if the genre data 14 is a short-time play type game, shooting game, action game, racing game, or the like, the control part 47 may be supplied with control data so as to set the save function ineffective.

The control part 47 controls the entire operation on the basis of the data 19 concerning the game and inputted from the reproduction processing parts 33, 36, and 41. Specifically, the control part 47 executes the data 19 concealing the game when fee-charge could be carried out at the fee-charge processing part 43 on the basis of the fee-charge method determined by the (determination part 42. The control part 47 proceeded with the game in accordance with the input signal from the operation part 51 during the game.

Further, the data processing apparatus 30 comprises a memory interface (hereinafter simply called a memory I/F) 49 to which a memory 48 is attached. This memory 48 is attachable to and detachable from the apparatus body and records saving data when data is saved in the middle of progress of the game. If this memory 48 is attached to the memory I/F 49 of another apparatus, the game can be continued halfway even in the another apparatus.

The saving data may be stored not only into the memory 48 but also into the memory provided in the ROM type cassette 31, a recordable area provided at a part of the ROM type optical disc 34, or a memory provided in the storage part 40 or the card inserted in the card reader.

The data processing apparatus 30 comprises a display part 50 which is constructed by a LCD (Liquid Crystal Display), a CRT (Cathode-ray Tube), and the like for displaying the game contents, and an operation part 51 which is constructed by an input device of an operation lever type like a joy stick or a spherical input device like a track ball, operated by the user in accordance with contents displayed on the display part 50, and an operation pail 51 constructed by a keyboard, a mouse, and the like. The user operates the operation part 51 in accordance with the displayed contents based on the data 19 concerning the game displayed on the display part 50. The operation part 51 supplies the control part 47 with an output signal according to the operation of the user.

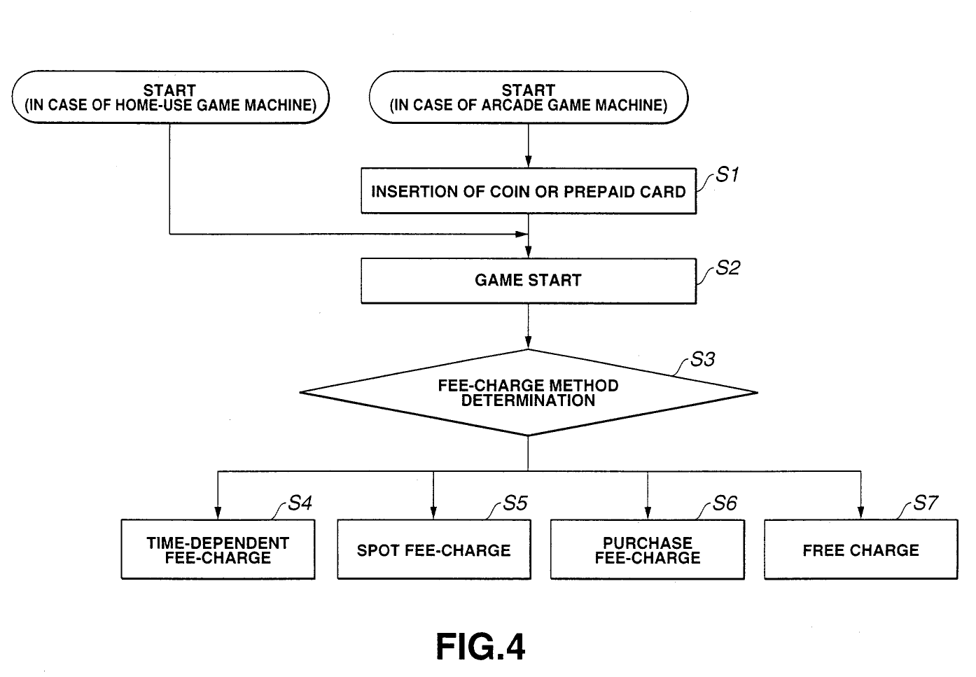

Next, with reference to FIG. 4, explanation will be made of a procedure in which the data processing apparatus 30 identifies the fee-charge method.

Suppose that the data processing apparatus 30 is an arcade game machine for professional use which is placed in a game arcade. When coins are inserted into the coin insertion part 44 or a card is inserted into the card reader 45, the fee-charge processing part 43 detects the sum of inserted coins or the balance of the card, in the step S1. In the step S2, the user presses a start key of the operation part 51, and then, the operation part 51 supplies this signal to the control part 47. The control part 47 reads program data shown in FIG. 1 from the ROM type cassette 31, ROM type optical disc 34, or storage part 40. If the data processing apparatus 30 is a home-use game machine, the control part 47 starts processing from the step S2.

In the step S3, the determination part 42 determines the fee-charge method to execute the data 19 concerning the game, based on the fee-charge method identification data 16 whose program data has been extracted by the production processing parts 33, 36, and 41. Specifically, the determination part 42 goes to the step S4, if the fee-charge method identification data 16 extracted from the program data is “0X01” (time-dependent fee-charge). If the fee-charge method identification data 16 is “0X10” (spot fee-charge), the part 42 goes to the step S5. If the data 16 is “01XX” (purchase), the part 42 goes to the step S6. If the fee-charge method identification data 16 is “0000” (free charge), the part 42 goes to the step S7. The determination part 42 outputs this determination result to the fee-charge processing part 43.

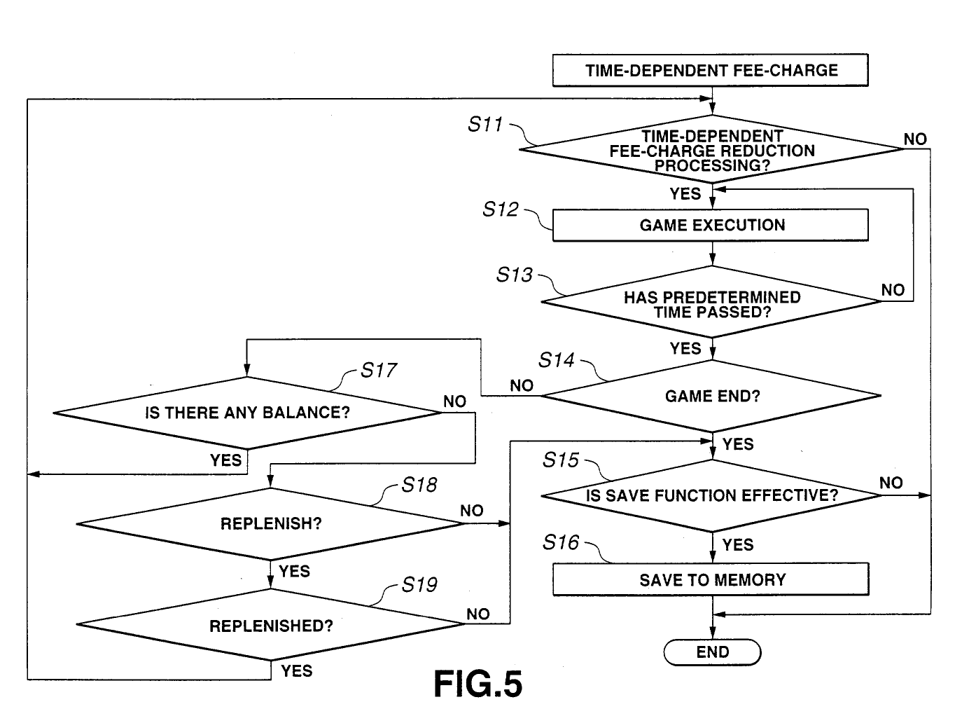

Here, the time-dependent fee-charge and the spot fee-charge are adopted mainly when the data processing apparatus 30 is an arcade game machine. Time-dependent fee-charge is mainly adopted to long-time play type games which take a long time until one game ends. The spot fee-charge is mainly adopted to short-time play type games which take a short time until one game ends. At first, referring to FIG. 5, explanation will be made of an operation where the determination part 42 determines the time-dependent fee-charge adopted to a long-time play type game in the step S4.

The determination part 42 outputs a determination result in the step S3 shown in FIG. 4 described above to the fee-charge processing 43. In the step S11, the fee-charge processing part 43 performs fee-charge processing in units of time periods, based on a determination result supplied from the determination part 42. For example, the fee-charge processing part 43 charges a fee of ¥20 per minute on the sum of coins inserted from the coin insertion part 44 or the balance of the inserted card, based on the fee-charge amount data. The fee-charge processing pail 43 outputs the fee-charge completion data to the control part 47 if time-dependent fee-charge could be carried out, i.e., if the fee-charge processing could be normally finished. If time-dependent fee-charge could not be carried out, i.e., if the fee-charge processing could not be finished normally, the fee-charge processing pail 43 outputs the fee-charge incompletion data to the control part 47. If the fee-charge has been completed in the step S11, the control part 47 goes to the step S12 and executes the game. Alternatively, if the fee-charge has not been completed in the step S11, the control part 47 displays a shortage amount on the display part 50 or terminates the processing. At this time point, the user can insert another coin into the coin insertion part 44 of the game machine, to continue the processing as will be described later.

In the step S13, the control part 47 determines whether or not a predetermined time period has passed. If the predetermined time period has passed, the control part 47 goes to the step S14. Alternatively, if the predetermined time period has passed, the control part 47 repeats the step S12. In the step S14, the control part 47 terminates the game. The control part 47 displays, on the display part 50, whether the game should be continued or stopped. If the user operates the operation part 51 thereby to input a continuation signal for continuing the game from the operation part 51, the control part 47 goes to the step S17. If a pause signal for pausing the game is inputted from the operation part 51, the control part 47 goes to the step S15.

In the step S15, the save function control part 46 controls the save function, based on the control data 15 inputted from the reproduction processing parts 33, 36, and 41. That is, the save function control part 46 sets the save function ineffective if the control data 15 is “00”. Alternatively, if the control data 15 is “01”, the save function is set effective. When the save function is effective, the control part 47 goes to the step S15 and records saving data onto the memory 48 attached to the memory I/F 49. When the save function is ineffective, the processing is terminated. This saving data includes data concerning how far the game has proceeded, data concerning the score, and the like, which are necessary for the user to continue automatically the game next from the state where the game is paused.

In the step S14, the user operates the operation part 51 to select continuation of the game. Then, in the step S17, the fee-charge processing part 43 calculates the balance to determine whether or not the fee for a next predetermined time period can be charged, i.e., whether or not at least the amount of the smallest unit according to time-dependent fee-charge can be charged. The fee-charge processing part 43 returns to the step S11 and carries out the time-dependent fee-charge, if there still remains a balance based on the inserted coins or a balance of the inserted card, which is enough to charge the fee based on the fee-charge data 17. Alternatively, if there is no balance of the inserted coins or the card, the fee-charge processing part 43 outputs a shortage signal indicating shortage of money, to the control part 47. In the step S18, the control part 47 displays a request for replenishing the shortage amount on the display part 50. If the user operates the operation part 51 to input a signal indicating that the shortage amount will not be replenished, the control pail 47 goes to the step S15. Alternatively, if the user operates the operation part 51 to input a signal indicating that the shortage amount will be replenished, the control part 47 goes to the step S19. In the step S19, the fee-charge processing part 43 determines whether or not the shortage amount has been replenished by insertion of another coin into the coin insertion pail 44, insertion of another card, or the like. If the shortage amount has been replenished, the fee-charge processing pail 43 determines that the fee-charge processing has been normally carried out, and outputs fee-charge completion data to the control part 47. If the shortage amount has not been replenished, the control part 47 determines that fee-charge processing has not been normally carried out, and outputs fee-charge incompletion data to the control part 47. If the fee-charge completion data is supplied, the control part 47 goes to the step S11 and performs fee-charge processing. If the fee-charge incompletion data is supplied, the control part 47 goes to the step S15.

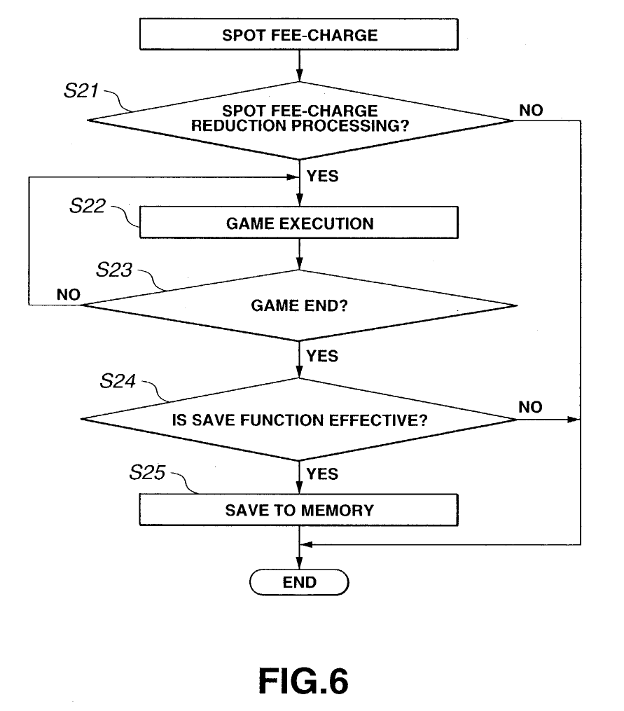

Next, with reference to FIG. 6, explanation will be made of an operation in case where the determination part 42 determines the spot fee-charge to be adopted to a short-time play type game in the step S3 and goes to the step S5.

The determination part 42 supplies the fee-charge processing part 43 with a determination result indicating that the fee-charge method is the spot fee-charge. In the step S21, the fee-charge processing part 43 performs the spot fee-charge processing, based on the fee-charge amount data 17. For example, the fee-charge processing part 43 charges a fee of ¥100 per game on the sum of coins inserted from the coin insertion part 44 or the balance of the inserted card. If the spot fee-charge could be carried out, i.e., if the fee-charge processing could be completed normally, the fee-charge processing part 43 outputs fee-charge completion data to the control part 47. Alternatively, if the spot fee-charge could not be carried out, i.e., if the fee-charge processing could not be completed normally, the fee-charge processing part 43 outputs fee-charge incompletion data to the control part 47. When the fee-charge is completed, the control part 47 goes to the step S22 and executes the game. When the fee-charge is not yet completed, the control part displays the shortage amount on the display part 50 or terminates the processing. At the time point when the user sees the shortage of money on the display part 50, the user can also insert coins to replenish the shortage amount and continues the game.

In the step S23, the control part 47 determines whether or not the game has ended. If the game has not ended, the control part 47 repeats the step S22. Upon end of the game, the control part 47 goes to the step S24. In the step S24, the save function control part 46 controls the save function, based on the control data 15 inputted firm the reproduction processing parts 33, 36, and 41. If the save function is effective based on the control data supplied from the save function control part 46, the control part 47 goes to the step S25 and records saving data onto the memory 48 attached to the memory I/F 49. If the saving function is ineffective, the control part 47 ends the processing.

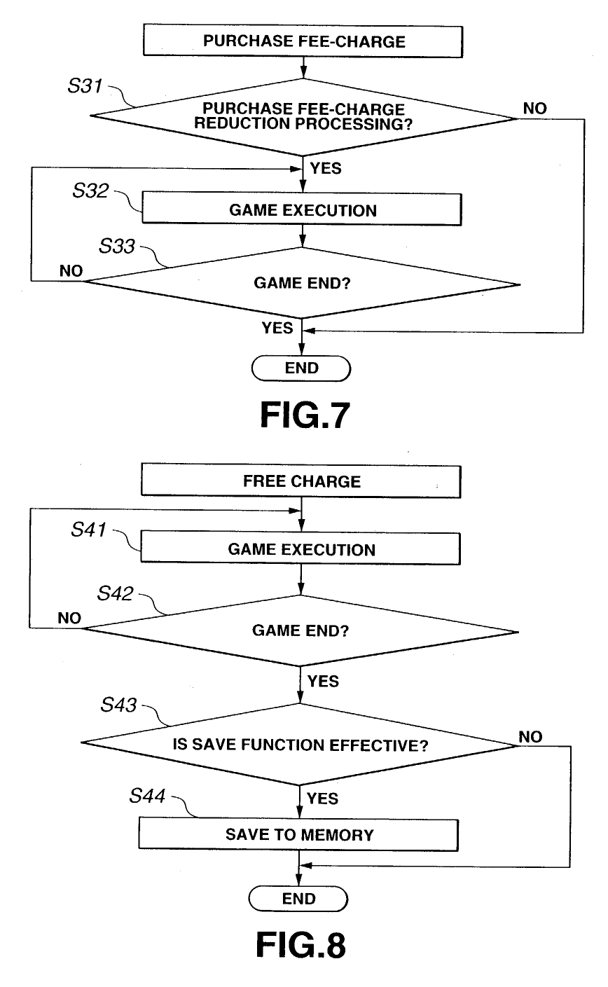

The time-dependent fee-charge and the spot fee-charge are used when the data processing apparatus 30 is an arcade game machine. However, when the data processing apparatus 30 is a home-use game machine, the fee-charge method of purchase or free charge explained below will be used in addition to the time-dependent fee-charge and the spot fee-charge described above. At first, with reference to FIG. 7, explanation will be made of an operation where the determination part 42 determines the purchase in the step S3 and goes to the step S6.

The determination pail 42 supplies the fee-charge processing part 43 with a determination result saying that the fee-charge method is purchase, the fee-charge processing part 43 carries out purchase in the step S31, based on the fee-charge amount data 17. For example, the fee-charge processing part 43 charges a fee of ¥2,000 upon the sum of coins inserted from the coin insertion part 44 or the balance of the inserted card. If the fee-charge processing part 43 could carry out the fee-charge for purchase in the step S31, i.e., when the fee-charge processing was completed, the fee-charge processing pail 43 outputs fee-charge completion data to the control part 47. Alternatively, if the fee-charge for purchase could not be carried out normally in the step S31, i.e., when the fee-charge processing was not completed normally, the fee-charge processing part 43 outputs fee-charge incompletion data to the control part 47. If it is determined that the fee-charge has been completed, the control part 47 goes to the step S32 and executes the game. If it is determined in the step 31 that the fee-charge has not been completed, the control part 47 displays the shortage amount on the display part 50 or terminates the processing. Of course, if the user inserts coins or the like at this time point to replenish the shortage amount, the amount necessary for purchase of the game is satisfied so that the purchase is concluded. In the step S33, the control part 47 determines whether or not the game has ended. If the game has not ended, the step S32 is repeated. Thereafter, fee-charge processing is not carried out any more on the data 19 concerning the purchased game, which is the game as a content. The user can freely play and enjoy the game.

Next, with reference to FIG. 8, explanation will be made of the operation where the determination part 42 determines in the step S3 that the fee-charge method identification data 16 is free and applies to game software such as a sample or the like and goes to the step S7.

The determination part 42 outputs a determination result saying that the fee-charge method, to the control part 47. The control part 47 then executes the game in the step S41. In the step S42, the control part 47 determines whether or not the game has ended. If the game has not ended, the step S41 is repeated.

Subsequently, in the step S43, the save function control part 46 controls the save function on the basis of the control data 15 inputted from the reproduction processing parts 33, 36, and 41. If the save function is effective based on the control data supplied from the save function control part 46, the control part 47 goes to the step S44 and records saving data onto the memory 48 attached to the memory I/F 49. Alternatively, if the save function is ineffective, the control part 47 terminates the processing. For example, when this program data which is the game software is distributed as a sample, the fee-charge method for free charge can be set and the save function can be set ineffective, thus restricting the function.

In the data processing apparatus 30 as described above, fee-charge processing can be performed in accordance with the type of the data 19 concerning the game. That is, the data processing apparatus 30 charges a fee in correspondence with the play time, i.e., the time period for which the user is executing the game, if the data 19 concerning the game is a RPG, simulation game, or long-time play type game which requires a long time until one game ends. Thus, the user can enjoy the long-time play type game not only by a home-use game machine but also by an arcade game such as a game arcade.

If the data processing apparatus 30 is a home-use game machine, the fee-charge processing may be carried out in the side of the server apparatus.

The present invention described above has been explained with reference to an example of game software. However, the data 19 concerning the game may be an article such as a musical piece, cinema, book, or the like. If the data is a musical piece, the fee-charge method identification data 16 may make identification among the reproduction fee-charge per song or album which is charged every time when one song or album is reproduced, the time-dependent fee-charge which is charged in accordance with the reproduced time period, and the purchase fee-charge which is charged when a song is purchased. Alternatively, in case of a cinema, identification may be made among the fee-charge per cinema (title) which is charged every time when one cinema (title) is reproduced, the time-dependent fee-charge which is charged in accordance with the reproduced time period, and the purchase fee-charge which is charged when one cinema title is purchased. In case of a book, identification may be made among the fee-charge per book (title) which is charged for every book (title), the fee-charge per page which is charged for every page, the time-dependent fee-charge which is charged in accordance with the reproduced time, and the purchase fee-charge which is charged when one book (title) is purchased.

### Industrial Applicability

According to the present invention, fee-charge method identification data depending on the type of its content is provided in the header part, so that fee-charge processing can be performed in compliance with the feature of the content. Therefore, when the content is a game, game software like a long-time-play type game which is not preferred as an arcade game can be played even in a game arcade.

1. A recording medium on which recording data constructed by a header data part and a data part, which is continuous to the header data part and includes data of a content, is recorded, wherein the header data part includes fee-charge method identification data for identifying a fee-charge method when executing an operation based on the data in the data part.

2. The recording medium according to claim 1, wherein the fee-charge method identification data indicates at least one of data expressing time-dependent fee-charge by which a fee is charged in units of time periods for executing the operation based on the data of the data part, and data expressing fee-charge by which a fee is charged every time when the operation based on the data of the data part.

3. The recording medium according to claim 1, wherein the header data part further includes identification data expressing a type of the data of the content recorded on the data part, and the fee-charge method identification data is set based on the identification expressing the type.

4. The recording medium according to claim 1, wherein the header data part further includes data concerning a fee-charge amount for making fee-charge processing, based on the fee-charge method identified by the fee-charge method identification data.

5. The recording medium according to claim 1, wherein the header data part further includes identification data expressing whether or not a function to hold a state in which execution of an operation is paused based on the data in the data part.

6. The recording medium according to claim 1, wherein the data of the content is data concerning a game.

7. The recording medium according to claim 1, wherein the data of the content is data concerning an authorized work.

8. A data processing method for a recording medium comprising:
a step of determining fee-charge method identification data extracted from recording data read from a recording medium on which the recording data constructed by a header data part and a data part, which is continuous to the header data part and includes data of a content, is recorded, with the header data part including the fee-charge method identification data for identifying a fee-charge method when executing an operation based on the data in the data part;
a step of carrying out fee-charge processing, based on the determined fee-charge method; and
a step of starting execution of the operation based on the data of the data part if it is determined that the fee-charge processing has been completed normally.

9. The data processing method according to claim 8, wherein the header data part of the recording data further includes data expressing a fee-charge amount, and the method performs fee-charge set by the data expressing the fee-charge amount, based on the determined fee-charge method.

10. The data processing method according to claim 8, wherein if the fee-charge processing has not been completed normally, the execution of the operation based on the data of the data part is terminated.

11. The data processing method according to claim 8, wherein if the fee-charge processing has not been completed normally, warning is displayed.

12. A data processing method for a recording medium comprising:
a step of determining fee-charge method identification data extracted from data constructed by a header data part and a data part, which is continuous to the header data part and includes data of a content, with the header data part including the fee-charge method identification data for identifying a fee-charge method when executing an operation based on the data in the data part;
a step of carrying out fee-charge processing, based on the determined fee-charge method; and
a step of starting execution of the operation based on the data of the data part if it is determined that the fee-charge processing has been completed normally.

13. The data processing method according to claim 12, wherein the header data part of the recording data further includes data expressing a fee-charge amount, and the method performs fee-charge set by the data expressing the fee-charge amount, based on the determined fee-charge method.

14. The data processing method according to claim 12, wherein if the fee-charge processing has not been completed normally, the execution of the operation based on the data of the data part is terminated.

15. The data processing method according to claim 12, wherein if the fee-charge processing has not been completed normally, warning is displayed.

16. A data processing apparatus comprising:
a reproduction part which reproduces data constructed by a header data part and a data part, which is continuous to the header data part and includes data of a content, with the header data part including fee-charge method identification data for identifying a fee-charge method when executing an operation based on the data in the data part;
a determination part which determines the fee-charge method identification data extracted by the reproduction part;
a fee-charge processing part which performs fee-charge processing, based on the fee-charge method determined by the determination part; and
a control part which starts execution of the operation based on the data of the data part when it is determined that the fee-charge processing has been completed normally.

17. The data processing apparatus according to claim 16, wherein the header data part of the recording data further includes data expressing a fee-charge amount, and the fee-charge processing part performs fee-charge set by the data expressing the fee-charge amount, based on the determined fee-charge method.

18. The data processing apparatus according to claim 16, wherein the header data part further includes function identification data expressing whether or not a function to hold a state in which the execution of the operation based on the data of the data part is paused should be operated, and the apparatus further comprises a function control part, which is supplied with the function identification data extracted by the reproduction part and supplies the control part with control data based on a result obtained by identifying the function identification data.

19. The data processing apparatus according to claim 18, wherein the control part makes data for holding the state in which the execution of the operation based on the data of the data part is paused, stored based on the control data from the function control part.

20. The data processing apparatus according to claim 19, further comprising a write part which writes, onto a memory, data for holding the state in which the execution of the operation based on the data of the data part is paused by the control part.

21. The data processing apparatus according to claim 20, wherein a memory onto which the data for holding the state in which the execution of the operation based on the data of the data part is paused is attached to and detached from the write part.

22. The data processing apparatus according to claim 16, wherein the control part terminates the execution of the operation based on the data of the data part if the fee-charge processing has not been completed normally.

23. The data processing apparatus according to claim 16, wherein the control part makes warning displayed if the fee-charge processing has not been completed normally.

24. A game apparatus comprising:
a reproduction part which reads and reproduces program data from a recording medium on which the program data constructed by a header data part and a data part, which is continuous to the header data part and includes data of a content, is recorded, with the header data part including fee-charge method identification data for identifying a fee-charge method when executing an operation based on the data in the data part;
a determination part which determines the fee-charge method identification data extracted by the reproduction part;
a fee-charge processing part which performs fee-charge processing, based on the fee-charge method determined by the determination part; and
a control part which starts a game based on data of the data part, which concerns the game, execution of the operation based on the data of the data part when it is determined that the fee-charge processing has been completed normally.

25. The game apparatus according to claim 24, wherein the header data part of the program data further includes data expressing a fee-charge amount, and the fee-charge processing part performs fee-charge set by the data expressing the fee-charge amount, based on the determined fee-charge method.

26. The game apparatus according to claim 24, wherein the header data part further includes function identification data expressing whether or not a function to hold a state in which the execution of the operation based on the data of the data part is paused should be operated, and the apparatus further comprises a function control part, which is supplied with the function identification data extracted by the reproduction part and supplies the control part with control data based on a result obtained by identifying the function identification data.

27. The game apparatus according to claim 26, wherein the control part makes data for holding the state in which the execution of the operation based on the data of the data part is paused, stored based on the control data from the function control part.

28. The game apparatus according to claim 27, further comprising a write part which writes, onto a memory, data for holding the state in which the execution of the operation based on the data of the data part is paused.

29. The game apparatus according to claim 28, wherein a memory onto which the data for holding the state in which the execution of the operation based on the data of the data part is paused is attached to and detached from the write part.

30. The game apparatus according to claim 24, wherein the control part terminates the game based on the data of the data part if the fee-charge processing has not been completed normally.

31. The game apparatus according to claim 24, wherein the control part makes warning displayed if the fee-charge processing has not been completed normally.
